(19) United States
(12) Patent Application Publication
(10) Pub. No.: US 2004/0243944 A1
(43) Pub. Date: Dec. 2, 2004

(54) Graphical user interface for viewing interactions between web service objects

(76) Inventors: Mark L. Sabiers, Fort Collins, CO (US); David C. Davidson, Windsor, CO (US); Jay D. Knitter, Wellington, CO (US)

Correspondence Address: HEWLETT-PACKARD COMPANY, Intellectual Property Administration, P.O. Box 272400, Fort Collins, CO, 80527-2400, US

(21) Appl. No.: 10/448,646

(22) Filed: May 30, 2003

(51) Int. Cl. G09G 5/00

(52) U.S. Cl. 715/853; 715/854; 715/738

(57) ABSTRACT

A method and apparatus is disclosed for representing Web service activity in a user interface. Web service objects are represented by graphical Web service components of the user interface. The Web service components are arranged in a generally in a row, with interconnection components displayed substantially parallel to the row. The interconnection components are displayed sequentially based on a sequence of interactions between the Web service objects.

### FIELD OF THE INVENTION

The present disclosure relates in general to graphical user interfaces used to view interactions between Web service objects.

### BACKGROUND

Initially, content published on the World Wide Web was in the form of static pages that were downloaded to a user's browser. The browser interpreted the page for display, as well as handling user input to objects such as forms or buttons. Lately, the emergence of what are known as “Web services” have been used extend the Web's capability to provide dynamic content that is accessible by other programs besides browsers.

Web services are network-based (particularly Internet-based) applications that perform a specific task and conform to a specific technical format. Web services are represented by a stack of emerging standards that describe a service-oriented, application architecture, collectively providing a distributed computing paradigm having a particular focus on delivering services across the Internet.

Generally, Web services are implemented as self-contained modular applications that can be published in a ready-to-use format, located, and invoked across the World Wide Web. When a Web service is deployed, other applications and Web services can locate and invoke the deployed service. They can perform a variety of functions, ranging from simple requests to complicated business processes.

Web services are typically configured to use standard Web protocols such as Hypertext Transfer Protocol (HTTP), Hypertext Markup Language (HTML), Extensible Markup Language (XML) and Simplified Object Access Protocol (SOAP). HTTP is an application-level protocol commonly used to transport data on the Web. HTML and XML are formatting protocols typically used to handle user input, encapsulate user data, and format output for display. SOAP is a remote procedure call (RPC) and document exchange protocol often used for requesting and replying to messages between Web services.

The use of Web services has made the browser a much more powerful tool. Far from serving simple, static Web pages, Web services can handle tasks as complex as any computer program, yet can be accessed and run anywhere due to the ubiquity of the Internet and its associated protocols.

The complex behaviors provided by Web services require more than standard HTML layout skills to implement. The task of writing and debugging Web services falls to computer programmers. Programmers typically design Web services, since Web services use instructions like traditional programming languages. However, unlike traditional computer programs, Web services are designed primarily for easy interaction with other Web services.

Although traditional programs can be designed to interact with other programs, such interaction is usually limited. Most computer programs can handle simple interactions such as cut and paste, but full interaction such as remote method invocation between disparate programs is the exception rather than the rule.

In contrast, Web services are designed for interaction. This interactivity has been enhanced by the fact they are built upon standard, open, widely adopted, and well understood protocols. It easier than ever to deploy independently developed Web services that interact naturally. However, this high level of interaction makes testing and debugging Web services more difficult. When developing a unified application, standard tools such as debuggers can be used to track program execution. However, Web services may involve multiple programs interacting on various computers anywhere in the world. These interactions may be hard to predict and track during run-time, especially since some public Web services may not be accessible by developers at a troubleshooting level.

### SUMMARY

Methods and apparatus are disclosed for representing a sequence of interactions between Web service objects. In one embodiment, a plurality of Web service graphical components represent associated Web service objects and are generally arranged in a row are displayed of a graphical user interface. A plurality of interconnection graphical components are generally oriented parallel to the row of Web service graphical components. The interconnection components appear in the user interface in order of occurrence of an associated interaction of the sequence of interactions between the Web service objects. The interconnection components are positioned relative to Web service graphical components that represent the Web service objects involved in the associated interaction and relative to the order of occurrence of the interaction. The interconnection components are arranged to have an extent approximately equal to a distance between the Web service graphical components that represent the Web service objects involved in the associated interaction.

### BRIEF DESCRIPTION OF THE DRAWINGS

FIG. 1 is a system diagram showing implementation of a graphical user interface according to embodiments of the present invention;

FIG. 2 is an example graphical user interface according to embodiments of the present invention;

FIG. 3 is an example graphical user interface with a message text display window according to embodiments of the present invention;

FIG. 4 is a diagram of a Web services GUI system according to embodiments of the present invention;

FIG. 5 is a flowchart illustrating a routine for illustrating graphical components in a GUI according to embodiments of the present invention;

FIG. 6 is a flowchart illustrating an alternate routine for illustrating graphical components in a GUI according to embodiments of the present invention; and

FIG. 7 is a diagram of a system in which a graphical user interface may be deployed according to embodiments of the present invention.

### DETAILED DESCRIPTION

In the following description of various embodiments, reference is made to the accompanying drawings which form a part hereof, and in which is shown by way of illustration various example manners in which the invention may be practiced. It is to be understood that other embodiments may be utilized, as structural and operational changes may be made without departing from the scope of the present invention.

In general, the present disclosure relates to a method and apparatus for visually representing interactions between Web service objects. A graphical user interface (GUI) is used to represent an arrangement of Web service objects as graphical components. Interactions (e.g. messages) between Web service objects may be represented by interconnection components displayed between the Web service components. The interconnections components may be arranged substantially parallel beneath the Web service components in a stack arrangement. Interconnection components may be added to the stack in the order that their associated interactions are arranged. Typically, the interactions are sequenced by time, so that the newest interconnection components are added to the end (in this case the bottom) of the stack.

A GUI according to embodiments of the present invention is useful in analyzing interactions that occur during invocation of Web services. Web Services are network-based (particularly Internet-based) applications. A Web service may include any service, such as data access or computation, that is available over the Internet. Web services are independent of operating systems, computer hardware, or programming languages. One advantage of Web services is that they can be accessed programmatically. Therefore application developers can leverage Web services to easily integrate remote data sources and computational services into computer programs.

Often, Web services are described in terms of Web objects. The term “Web objects” as used herein refers to any self-contained application that provides a set of Web services. Web services are often in the form of Internet-protocol-based services that allows the programmatic invocation of a Web service. These objects can be invoked across the World Wide Web by using standard protocols of the Web.

Web services are accessed via ubiquitous Web protocols and data formats, such as Hypertext Transfer Protocol (HTTP) and Extensible Markup Language (XML). At present, one popular Web service platform is XML used with HTTP.

XML is a text-based markup language that is currently used extensively for data interchange on the Web. XML is a data-encapsulation format that allows complex interactions between clients and services, as well as between components of a composite service, to be expressed. As with HTML, XML data is identified using tags, which are collectively known as “markup.” XML tags identify the data, and act as a field name for the data.

HTTP is an application-level transport protocol, and more particularly is a set of rules for exchanging files (text, graphic images, sound, video, and other multimedia files) on a network such as the World Wide Web. HTTP is the primary protocol used by Web browsers, as well as a popular choice for carrying Web services.

While the examples of Web services set forth herein are generally described in connection with XML and HTTP, it should be recognized that this is for illustrative purposes, and current and future types of protocols and data formats may also be employed. For example, other data formats may be used in whole or in part by Web services, including HTML and JavaScript. Similarly, other application-level data transport protocols may be used in whole or in part by Web services, including File Transfer Protocol (FTP), Session Initiation Protocol (SIP), and Simple Mail Transport Protocol (SMTP).

Web services represent a collection of several related technologies, and involve connections between at least two applications, in which queries and responses may be exchanged in XML over HTTP. These connections are sometimes described as remote procedure calls (RPC).

Web service technologies may be defined in terms of various technology layers. The core layers include a transport layer, such as TCP/IP and HTTP as previously described, in which XML messages may be communicated. A messaging layer using a format such as XML can be used for invoking RPCs across the Web. Two XML-related protocols, Simple Object Access Protocol (SOAP) and XML-RPC, represent a core layer of Web services that provide this functionality.

SOAP and XML-RPC are protocol specifications that define a uniform manner of passing XML-encoded data, as well as defining a manner to perform RPC using HTTP as the underlying communication protocol. XML-RPC is generally associated only with HTTP for transport, although SOAP can use other underlying protocols, such as Simple Mail Transfer Protocol (SMTP) to invoke RPCs.

Although Web service objects generally communicate using a standard protocol such as SOAP or XML-RPC, the objects themselves can be created using any programming technology known in the art. Web service objects can be compiled binaries (e.g. C/C++, Ada, Pascal, Lisp), scripts (e.g. Perl, Python) or interpreted objects (e.g. Java™, Visual Basic®). Two popular forms of Web objects are JavaServer Pages™ (JSP) and Enterprise Java Beans™ (EJB).

Web service objects 106 can be created in object oriented languages such as Java, although it is appreciated a Web service object 106 can be any Web service regardless of whether the underlying technology is actually object oriented. Further, although RPC mechanisms such as SOAP are becoming the standardized protocol for Web services, other existing Web technologies can be adapted for use as Web services. Therefore, any technology such as static HTML, Common Gateway Interface (CGI) scripts, Active Server Pages (ASP), Macromedia® Flash™ or other server-side technologies can be abstracted as Web service objects 106 for purposes of implementing embodiments of the present invention.

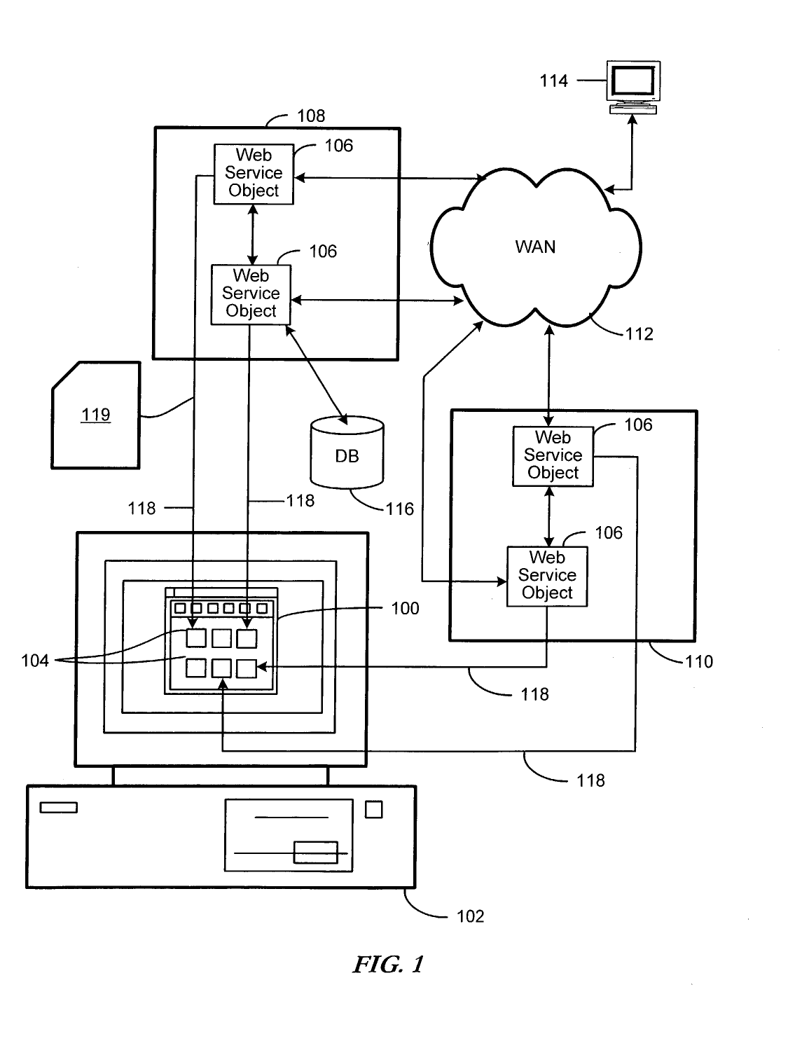

Referring now to FIG. 1, a representative system is illustrated that provides services according to embodiments of the present invention. A graphical user interface (GUI) 100 is displayed on a computing system 102. The computing system 102 illustrated is a personal computer, although any fixed or mobile computing device may be used to display a GUI 100.

The GUI 100 incorporates one or more graphical components 104 that are used to represent Web service objects 106 as well as communications between those objects 106. The Web service objects 106 are employed on Web servers 108, 110 connected to a network 112. The network 112 illustrated is a wide area network (WAN), such as the Internet. Those skilled in the art will appreciate that Web servers 108, 110, and Web service objects 106 can be utilized on any type of networks, such as Local Area Networks (LAN), wireless networks, point-to-point connections, etc.

In general, a client system 114 may use a browser to access a Web server 108, 110. The servers 108, 110 may fulfill client requests using one or more of the Web service objects 106. The Web service objects 106 can be programmed to perform tasks such as accessing a database 116 and creating dynamic Web pages for the client system 114.

The Web service objects 106 may often interact with other Web services objects 106 as indicated. These interactions may occur with Web service objects 106 on the same server or different servers 108, 110. A GUI 100 according to embodiments of the present invention can advantageously display these Web service interactions for a user of the computing system 102.

Typically, when invoking Web services, the various Web service objects 106 may be accessed by a user request or by other Web service objects 106 anywhere on the network 112. Therefore, the distributive nature of Web service objects 106 may make the interactions difficult for a Web services developer to view. The GUI 100 advantageously allows a developer (or other interested person such as a Web site administrator) to see interactions between Web service objects as represented by components 104 of the GUI 100.

The Web service objects 106 can communicate information (e.g. messages 119) to the GUI 100, as indicated by the connections 118. The connections 118 may be separate connections to either the GUI 100 or the components 104 of the GUI 100. Alternatively, there may be a single connection between the servers 108, 110 and the computing system 102, and all messages 119 are sent through this single connection. When the messages 119 are sent between machines, the connections 118 can be made through sockets, datagrams, messaging services/protocols, shared network files, etc. When the communication is between Web service objects on the same machine, connections 118 can be made through mechanisms such as shared memory, pipes, Windows events, inter-process communications (IPC), etc. The connections 118 can be point-to-point or provided over the WAN 112.

There is typically a one-to-one mapping between the Web service objects 106 and the GUI components 104, so that the user can track a Web service object 106 of interest by watching the associated component 104. However, other mappings may be desirable, such as representing a group of Web service objects 106 by a single component 104. Similarly, the GUI components 104 may also be used to represent interactions such as the passing of messages 119 between Web service objects 106.

The interactions between multiple Web service objects 106 during a transaction are also referred to herein as “conversations.” In general, Web service conversations are exchanges of data between Web service objects 106. For example, a conversation may include a time ordered collection of messages exchanged between a set of Web service objects 106. The conversations may also include extra data indicating the source, destination, and time of the messages, if such information not readily ascertainable from the messages themselves.

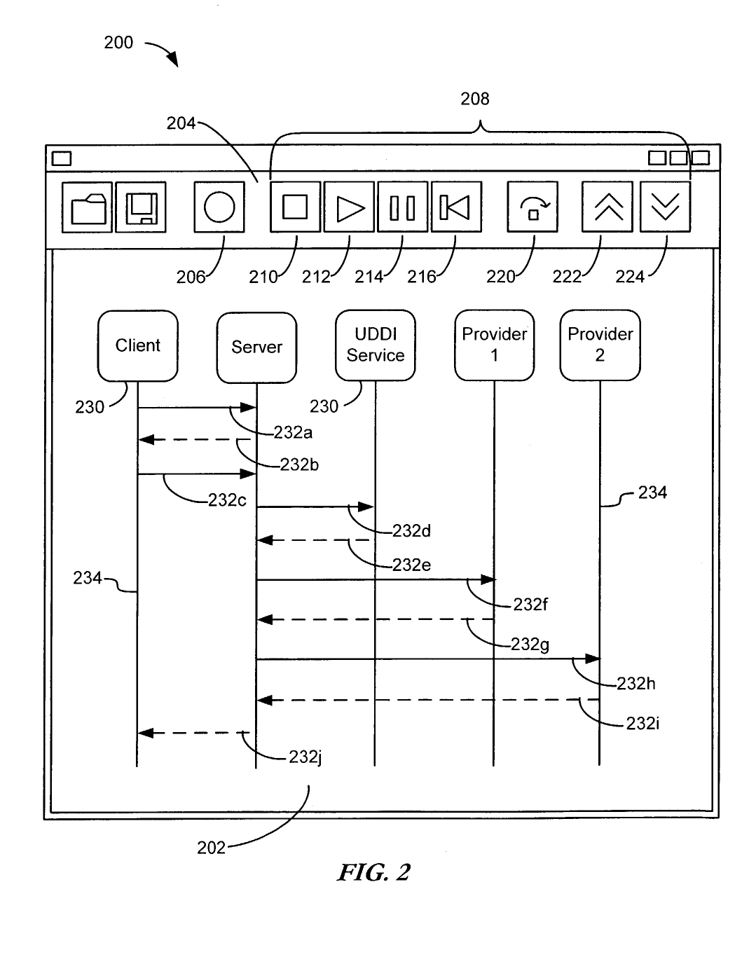

Turning now to FIG. 2, an example of a GUI 200 is shown according to embodiments of the present invention. The GUI 200 includes a display portion 202 with objects that can indicate sequences, activities, and states of Web service conversations. The GUI may also include a control portion 204 with user operable controls (e.g. buttons) configured to record and playback Web service conversations.

In general, the Web service conversations can be dynamically represented in the display portion 202 by drawing graphics primitives that represent individual interactions of the conversations. The graphics may be drawn in real-time, that is at substantially at the same time as the message is passed between Web service objects. The graphics may also be drawn in relation to stored conversation data. Although the stored data relates to historical conversations, the playback of this data simulates a real-time display of Web service conversations.

In either real-time or playback scenarios, the display draws a new graphics primitive or modifies an existing graphics primitive in response to each successive interaction of the conversation. Therefore the user can see not only the structure of the conversations (e.g. source, destination, type of interaction) but can get a sense of the timing of the interactions. The control portion 204 may be used to alter the rate of interaction playback (e.g. the time between drawing successive primitives) or change other aspects of the dynamic display.

The control portion 204 may include a recording control 206 and playback controls 208. The recording and playback controls 206, 208 are arranged to operate similar to hardware controls on tape decks and other media playback devices. In the example of FIG. 2, the controls 206, 208 are shown as pushbutton components having a graphic indicator shown on each button. However, it is appreciated that alternate types of GUI components (e.g. toggle buttons) and indicators (e.g. text) may be used in alternate configurations of the controls 206, 208.

In general, the recording control 206 allows capturing Web service conversations and storing the conversations in memory, and the playback controls 208 allow on-demand playback of stored Web service conversations. The playback controls 208 may include standard tape-deck-style controls such as stop 210, play 212, pause 214, and reset/rewind 216.

Because Web service conversations can be comprised of multiple discrete messages or data transfers, a step-through control 220 may be used that allows the playback of Web service conversations to be controlled in discrete steps, typically one message at a time. The playback controls 208 may also include speed controls 222, 224. The speed controls 222, 224 are used to adjust a rate of continuous playback speed of the Web service conversations.

The recording and playback controls 206, 208 can be used, among other things, to control the display portion 202 of the GUI 200. The display portion 202 includes graphical components that visually indicate communications between Web service objects. The display portion 202 of FIG. 2 includes Web service components 230 and interconnection components 232a-j according to various embodiments of the invention. The Web service components 230 (also referred to as “nodes”) are associated with Web service objects. The interconnection components 232a-j indicate communications between associated Web service objects.

The Web services components 230 can be represented by graphics such as the boxes shown in FIG. 2. The interconnection components 232a-j have endpoints that align with two or more of the Web services components 230 and can be used to indicate communications there between. The interconnection components 232a-j in this example are displayed as straight lines, although other shapes such as arcs or curves can be used.

The interconnection components 232a-j shown in FIG. 2 are arranged similarly to a Universal Modeling Language (UML) sequence diagram. A UML sequence diagram typically includes a top row of functional modules or nodes, represented here by Web services components 230. Each node 230 may include an extension line 234 extending vertically downward. The extension lines 234 are sometimes referred to as “lifelines” in UML parlance. A group of interconnection components 232a-j (drawn as horizontal arrowhead lines) are stacked below the nodes 230 and connected between the extension lines 234 to indicate a communication between the nodes 230. The dashed lines indicate a return (e.g. success/failure) to a procedure call or other communication event. A UML sequence diagram is read top to bottom, with the topmost lines representing the earliest events.

The order in which the interconnection components 232a-j may be introduced in the display depends on the order of the recorded sequence of interactions. Interactions recorded toward the beginning of the order are introduced in the display before interactions recorded toward the end of the order. For example, if the interactions are time-ordered, an interaction with an earlier timestamp is introduced in the display prior to an interaction with a later timestamp. It will be appreciated that in other embodiments, the interconnection components may presented simultaneously in the display, with the order connoted by the relative positions of the interconnection components.

The Web services components 230 and interconnection components 232a-j can be configured to give a visual indication of connection activity. This visual indication includes displaying of the components 230, 232a-j when the interactions first occur. The activity can also be represented in subsequent interactions by various techniques, such as varying component properties (e.g. color, line thickness) or by use of animations (e.g. marquee or “crawling dots”). In another arrangement, the interconnection component 232a-j can be alternately shown and hidden to indicate activity.

Whatever method is used to indicate activity, the Web services components 230 and interconnection components 232a-j can maintain an internal timer so that changes to the components 232a-j remain visible to the eye for some amount of time when active, then revert to the default appearance until active again. Although the illustrated display portion 202 includes a horizontal arrangement of nodes and lines, other arrangements may be incorporated in a GUI 200 according to embodiments of the present invention. For example, the Web service and interconnection components 230, 232a-j may be arranged vertically, with extension lines 234 oriented horizontally. The Web service and interconnection components 230, 232a-j may be drawn with other graphics primitives besides boxes and lines. For example, the interconnection components 232a-j may be shown as rectangles that contain a descriptive text inside the rectangle's border and a directional indicator at one or more edges (e.g. an arrow or triangle at one end). The edges of the rectangles would connect between nodes and/or extension lines 234 similar to the lines in a traditional UML diagram.

Both the Web services and interconnection components 230, 232a-j may be user-selectable. The user may select the component to determine information about the Web service objects or messages represented by the components 230, 232a-j. The information may be represented by a separate text dialog, an expansion of the component showing additional text, a cursor-attached text window (e.g. “tool tips”), or other methods known in the art.

The components 230, 232a-j may also be user-selectable to allow the user to rearrange the layout. The Web service components 230 may have one or more natural arrangements on the display portion 202 that are known by the user or evident from the input parameters. In some scenarios, it may be desirable to rearrange the Web service components 230 to show different aspects of the conversations. Similarly, the user may wish to manually rearrange some interconnection components 232a-j for a clearer view.

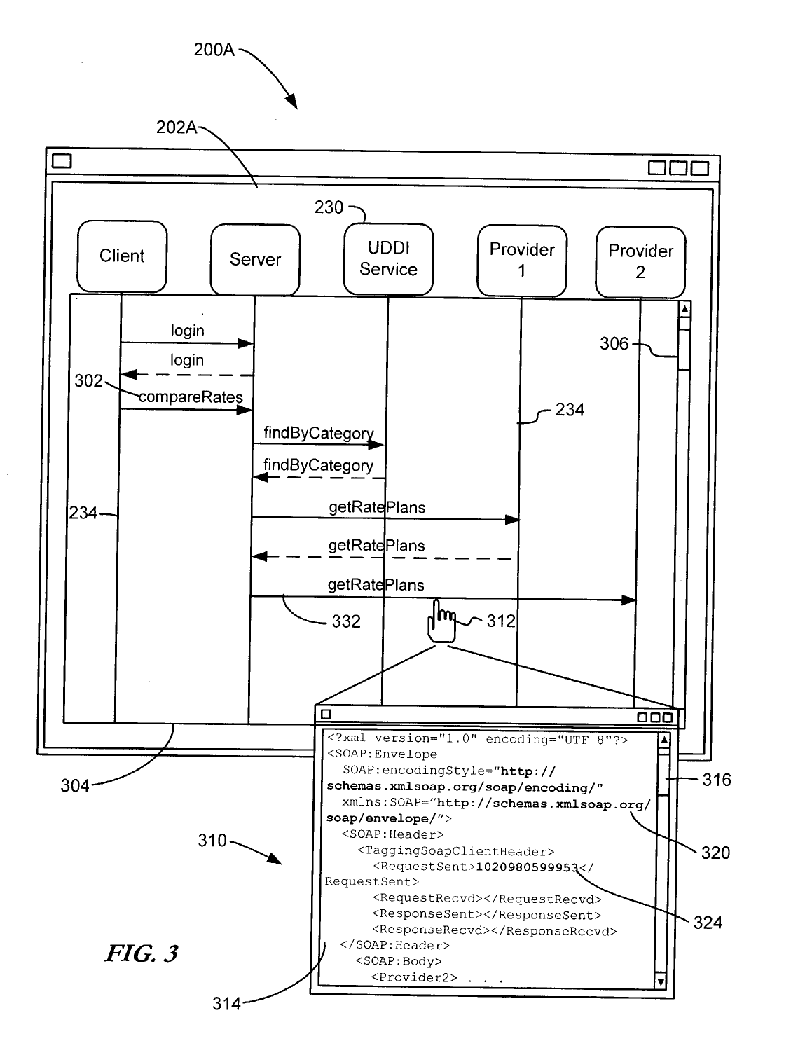

Turning now to FIG. 3 more details are shown of a GUI 200A according to embodiments of the present invention. In this example, no controls are shown with the GUI 200A. Although controls are useful for non-real-time playback of Web service conversations, the GUI 200A may arranged to monitor real time conversations where controls may not be needed. Alternatively, controls may be included elsewhere (e.g. a separate window), or aspects of the GUI behavior controlled from a command line or by using other input methods or devices.

The interconnection components 332 in FIG. 3 include text labels 302. The text labels 302 may include descriptors of the communications between web service objects. As shown in FIG. 3, the text labels 302 include the RPC method name being invoked, which conforms to the accepted practice in UML sequence diagrams.

The display portion 202A of the GUI 200A may also include a scroll window 304. The scroll window 304 is a movable graphics context that includes visible and hidden portions. The hidden portions are accessible by a scroll bar 306 or other GUI controls. The Web service components 230 are fixed outside the scroll window 304, thereby acting as a header for interconnection components 332 displayed in the window 304. The scroll window 304 in FIG. 3 is arranged to scroll vertically, thereby advantageously allowing the GUI 200A to display a large amount of conversation data (e.g. interconnection components 332) in a limited amount of space. The scroll window 304 may be configured to scroll automatically so that the newest data is always visible.

The GUI 200A may contain other scroll windows. For example, the entire graphical portion 202A may be horizontally scrollable (not shown) to visually display a large number of horizontally arranged Web service components 230 in a limited window space.

Also shown in FIG. 3 is a message content window 310 that can be used to display data of the Web service communications (e.g. messages). The message content window 310 may be displayed, for example, by selecting an interconnection component 332 with the cursor 312. The message content window 310 contains a graphical display arranged for presentation of the data transferred between Web service objects. Web services often transfer data using text-formatted protocols such as SOAP, therefore the message content window 310 may display the data in a text window 314.

The text window 314 may include scroll controls 316 to allow displaying the entire message in a fixed-height GUI window. The text window 314 may include syntax highlighting of the text to emphasize various parts of the message. Syntax highlighting involves changing text display characteristics for various elements of a message (e.g. tags, content, values attributes, operators, punctuation, comments, etc). Syntax highlighting is often achieved by altering text color, although other characteristics may be varied, including italicization, font, font size, boldness, background color, etc.

The text window 314 in FIG. 3 is displaying an XML-formatted SOAP message in a syntax-highlighted display. In this example, attributes 320 and values 324 are highlighted a particular color (indicated by bold-face text in the figure). Other colors may be used for tags, brackets, or any other message elements. Providing syntax highlighting in the message content window 310 advantageously allows users to visualize and locate pertinent parts of the messages.

Syntax highlighting typically involves passing the message text through a parser to locate various elements of the message syntax, and then adding visual changes to the appropriate text. Visual changes may be applied by any method appropriate to the programming language and graphical routines of the target computing system. In one example, the text window 314 may utilize a standard HTML layout engine to display the formatted text. In such an arrangement, the parser would convert the message to HTML-safe text (e.g. changing “<” to “&lt;”, etc.) and then add HTML tags to highlight the message syntax.

When using a text based message content window 310, other enhancements can be provided besides syntax highlighting. In one arrangement, the window 310 may parse the message for Uniform Resource Indicators (URI) and reformat the URI text as hyperlink text. Providing hyperlink text generally involves providing a visual indication (e.g. underline) that the text is hyperlinked, as well as providing a mechanism to access the underlying Internet resource. In the example shown in FIG. 3, a hyperlinking feature would allow the user to access the latest envelope schema from “http://schemas.xmlsoap.org/soap/envelope” by merely clicking on the attribute 320.

Although much Web service message traffic is text based, it is appreciated that some binary data may be embedded or linked to the messages. The message content window 310 may include other types of data viewers (e.g. hexadecimal text display for reading binary data, image/video viewer, sound player, etc.) when non-textual data is being transferred. For example, it is possible to attach data to a SOAP message either embedded in the message or as a Multipurpose Internet Mail Extension (MIME) attachment. When embedding the data in the message, the binary data is usually encoded using a scheme such as Base64 and then placed in the message as a string. When using a MIME attachment, the binary data is included after the SOAP message and is identified with a MIME “Content-Type” header similar to an email attachment. In either an embedded or attachment arrangement, the message content window 310 may include a resident data viewer, or may utilize a third party viewer in a similar fashion to a Web browser.

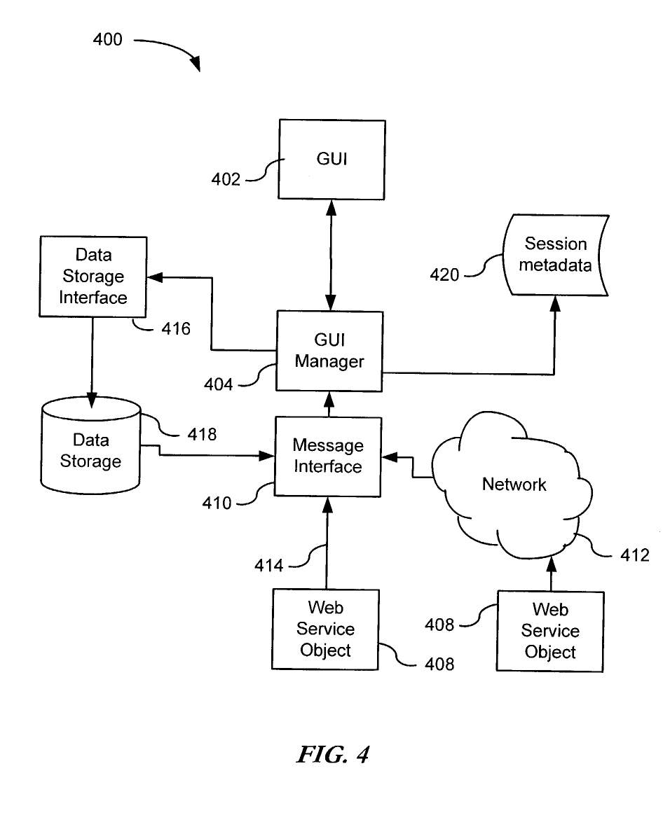

Referring now to FIG. 4, a system component diagram 400 is shown for a GUI according to embodiments of the present inventions. The functional components in FIG. 4 are abstractions of computing elements which may interface internally or externally with a system displaying the GUI. The functional components may be any combination of software or hardware, and may reside on one or many separate physical machines. The components may represent a single application process, multithreaded process, or independently running processes that communicate through IPC or networking.

The system 400 includes a GUI 402 that generally represents the user interface portion of the system. The GUI 402 provides a representation of Web service interactions to the user, such as seen in the display portions 202, 202A in FIGS. 2 and 3. The GUI 402 also handles user input events, such as button presses, mouse and keyboard input, etc. The user events are communicated to a GUI manager 404. The GUI manager 404 acts as a control center to interface the GUI 402 with other system components. In particular, the GUI manager 404 is connected to a message interface 410 and a data storage interface 416.

The Web service conversations displayed by the system 400 originate as messages passing between the Web service objects 408. These messages are communicated to GUI manager 404 through the message interface 410. The message interface 410 in this arrangement acts as a generic data communications interface usable by the GUI manager 404. Typically, the messages are communicated over a network 412, although a direct connection 414 (e.g. on the same machine) may be used as well. Also, the message interface 410 may be configured to playback message data from a data storage 418.

The system 400 reads data associated with Web service conversations and represents the data on the GUI 402. The data may be live (real-time or near-real-time), cached remotely (e.g. with the Web service objects 408), or cached locally on the data storage 418. Before viewing the data, the user may desire to define a set of session metadata 420 used to set up session parameters. Session metadata 420 is descriptive data used to categorize and/or describe data associated with a session. The metadata 420 may include such entries as the session name, Web service objects/nodes, filters, number of data entries, etc.

If the user is using the system to store or record remote data to storage 418, the metadata 420 may be stored with the message data. If the system 400 is used to play back stored data, this metadata 420 may be retrieved from the data storage 418 rather than input by the user. The metadata 420 may provide a description of the data source (e.g. live, remote host, data storage 418) that is then used to setup the message interface 410.

Once the session metadata 420 is prepared, the user initiates session playback from the GUI 402. The GUI manager can then read messages from the message interface 410 and send this data to the GUI 402. The GUI 402 uses the data to illustrate the message interactions to the user by changing appearance of graphical components.

Various techniques may be used to display the messages to the user. As previously described, a message is indicated by drawing and/or modifying an interconnection component 232a-j as seen in FIGS. 2 and 3. Depending on the user's needs, different behaviors may be desired when drawing interconnection components 232. The GUI 200 may use a time ordered view, where a new interconnection component is drawn for each message. In this view, each new message results in an associated interconnection component 232a-j be drawn at the bottom of the “stack.” Drawing the interconnection components 232a-j in an automatically scrolled window 304 (see FIG. 3) is especially useful in a time ordered view.

In another arrangement, the GUI 200 may be configured to draw the interconnection components in a retrace view. In retrace view, data having similar characteristics (e.g. messages having the same source node, destination node, and method identifier) are associated with a single interconnection component 232a-j. In this arrangement, the interconnection component is drawn at the first instance of an associated message. Thereafter, when a message having characteristics associated with the interconnection component 232a-j found, a visual attribute of the component 232a-j changes to indicate activity. A timer can be used to return the component 232a-j to its default visual state after the activity state has been displayed long enough to be noticed by the user.

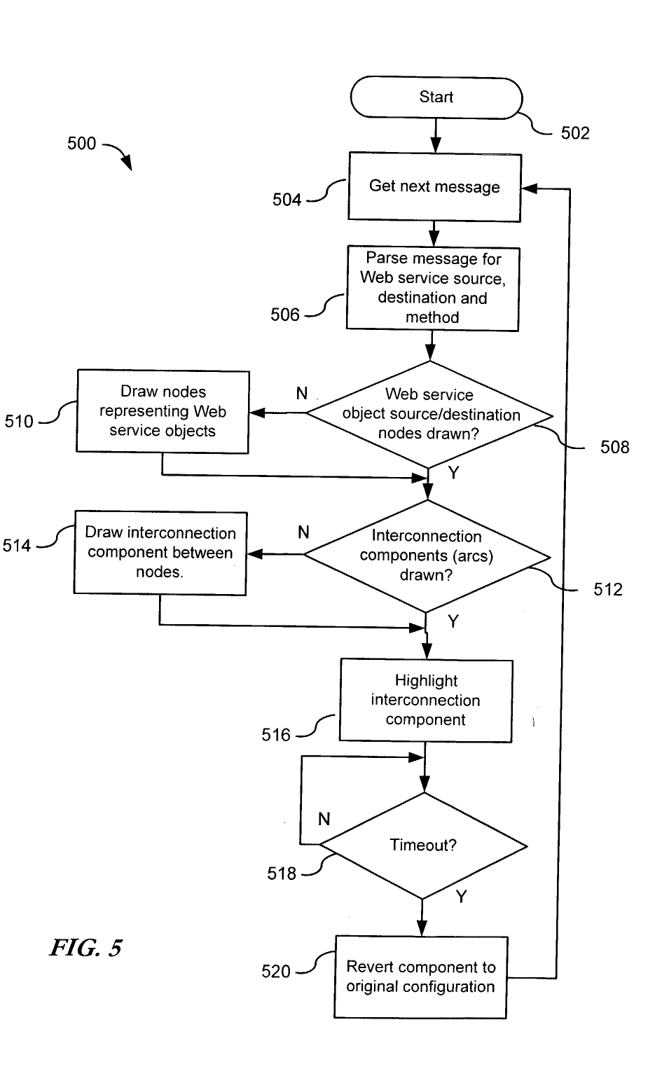

FIG. 5 is a flowchart 500 of an example subroutine for drawing a time ordered view or retrace view in the GUI in accordance with embodiments of the present invention. After the routine starts 502, a message is retrieved 504. In this example, it is assumed the routine will block waiting for the next message to be retrieved 504. Therefore, the loop traversing steps 504-520 can continue indefinitely until the subroutine is exited by some external event (e.g. end-of-file exception, user input). This infinite loop behavior is often useful in real-time displays, since no predetermined end-of-data is assumed.

After the message is retrieved 504, the message is parsed 506 to determine start and destination nodes, Web service RPC method, etc. The data retrieved from the parsing 506 is then used to determine whether the Web service components representing the nodes have been drawn 508. If the nodes have not yet been shown, then the Web service objects representing the source and/or destination nodes are drawn 510.

Once it has been determined that the Web service components have been drawn, a similar check 512 is performed for interconnection components. If the GUI is using a time ordered view, then the results of this check 512 is always “no” and a new interconnection component is drawn 514 for each message. If the GUI is using a retrace view, then a new interconnection component is only drawn 514 if no matching component exists.

Whether the GUI is using a time-ordered or retrace view, it may be desirable to visually highlight 516 the interconnection component to indicate that a message or other communication has occurred. Highlighting 516, as previously described, may include changing any manner of visual property of the interconnection component, such as line width or color. The highlighting 516 preferably remains visible long enough to be seen by the user, but later reverts to default visual properties, thereby giving the illusion of “flashing.” The timeout check 518 waits until a set amount of time has elapsed before reverting 520 the interconnection component's original characteristic. Although the timeout 518 is shown as a loop, it is appreciated that alternate (and more efficient) methods of implementing timeouts may be implemented. In one example, a thread can be spawned that blocks its execution for a set amount of time by using a function such as nanosleep( ). The thread then reverts 520 the indicated interconnection component upon expiration of the timer.

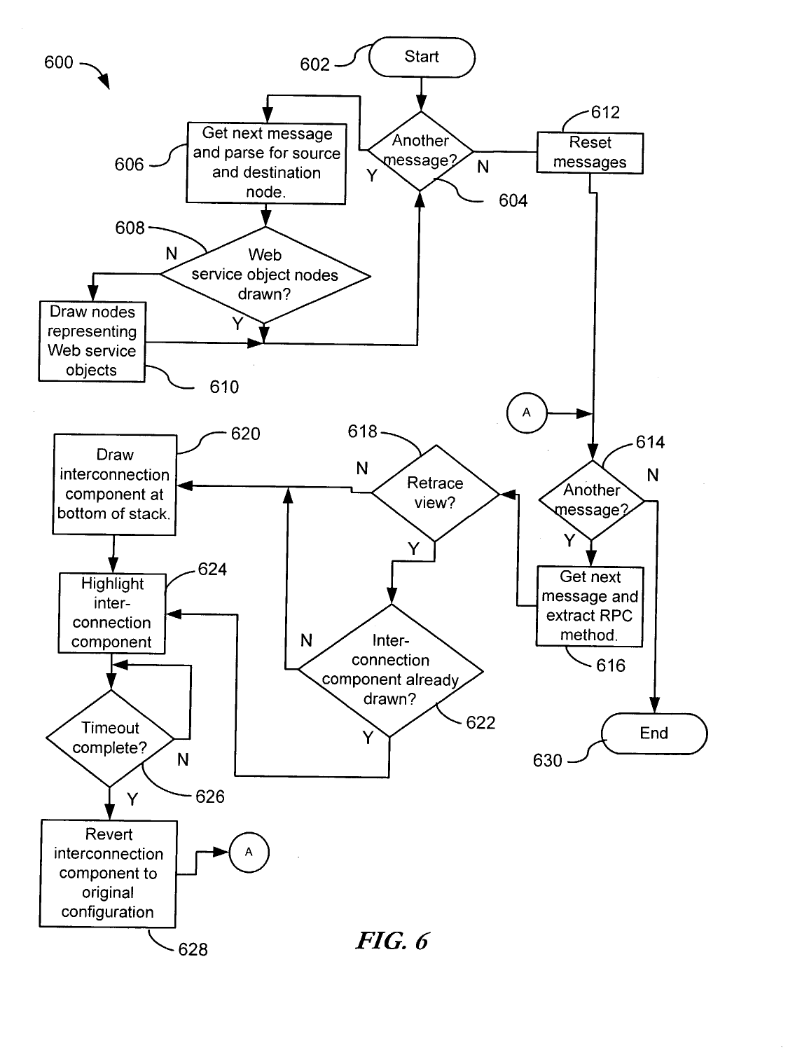

The flowchart 500 of FIG. 5 represents one example of drawing GUI components for a recorded or real-time representation of Web service conversations. In FIG. 6, an alternate approach is illustrated that may be useful for pre-compiled data sets. In the flowchart 600 of FIG. 6, it is assumed the routine begins 602 with a pre-ordered collection of Web service communication data. The collection is initialized and checked 604 for the next message. Assuming the next message is available (e.g. not at the end of the collection), the next message is extracted and parsed 606. Similar to the routine of FIG. 5, if the Web service components representing source and/or destination nodes are not yet rendered 608, they are drawn 610 appropriately. When the collection contains no more messages, the collection is reset 612.

Resetting the message collection 612 generally involves resetting a pointer or iterator back to the beginning of the collection. The messages are again checked, extracted, and parsed, 614, 616, this time extracting the RPC method that was invoked, as well as source and destination nodes. This data is used to draw the interconnection components.

If the system is not in retrace view 618, then the interconnection component is simply drawn and highlighted 620, 624. If the GUI is in retrace view 618, then a check 622 is made whether this interconnection component is already drawn. If not, then it is drawn and highlighted 620, 624. If the interconnection component is already drawn, it is just highlighted 624. Finally a timeout 626 is measured after which the arc is reverted to its initial state 628. This continues until the check 614 reveals no more messages, upon which the routine exits 630.

The flowcharts 500, 600 of FIGS. 5 and 6 are provided for purposes of illustration and not of limitation. Those skilled in the art will appreciate there are alternate operations and sequences that will provide similar functionality to a GUI according to embodiments of the present invention. For example, operations such as message parsing and displaying components could be executed in parallel by separate threads of execution instead of in a serial fashion as illustrated.

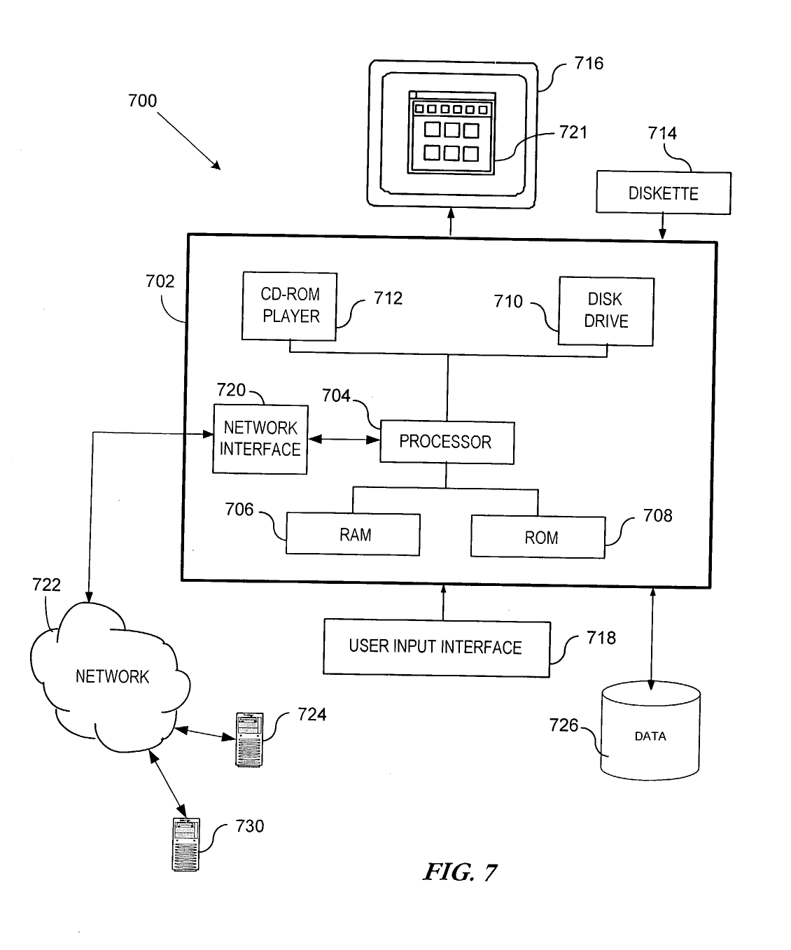

Turning now to FIG. 7, a system 700 is shown in which a GUI according to embodiments of the present invention may be employed. The system includes a computing apparatus 702 with a processor 704 and coupled to some form of data storage. The data storage may include volatile memory such as RAM 706. Other devices that the apparatus 702 may use for data storage and retrieval include a ROM 708, disk drive 710, CD-ROM 712, and diskette 714. A display 716 and user-input interface 718 are attached to the computing apparatus 702 to allow data input and display of the GUI 721. The computing apparatus 702 includes a network interface 720 that allows the apparatus to communicate with Web servers 724, 730 and other computing devices across a network 722.

In one embodiment of the invention, the computing apparatus 702 connects to Web objects running on the Web servers 724, 730. The Web objects may communicate directly or indirectly with the GUI 721 to provide a display of Web service conversations. The Web service conversations may be recorded to persistent storage 714, 710 or a database 726 and played back in the display 716.

From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention can be implemented in any combination of hardware and software.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

What is claimed is:

1. A graphical user interface for representing a sequence of interactions successively occurring over a period of time between Web service objects, comprising:
a plurality of Web service graphical components representing associated Web service objects and generally arranged in a row; and
a plurality of interconnection graphical components, each generally oriented parallel to the row of Web service graphical components, appearing in the user interface in order of occurrence of an associated interaction of the sequence of interactions between the Web service objects, positioned relative to Web service graphical components that represent the Web service objects involved in the associated interaction and relative to the order of occurrence of the interaction, and having an extent approximately equal to a distance between the Web service graphical components that represent the Web service objects involved in the associated interaction.

2. The graphical user interface of claim 1, wherein the Web service graphical components each include an extension line extending substantially perpendicular from the row of the Web service graphical components, each interconnection graphical component coupled to the extension lines from two or more Web service components.

3. The graphical user interface of claim 1, wherein a new interconnection graphical component is displayed for each interaction of the sequence of interactions.

4. The graphical user interface of claim 1, wherein a new interconnection graphical component is displayed for a specific interaction if an existing interconnection graphical component that represents another interaction has a selected set of characteristics that is different from a selected set of characteristics of the specific interaction, and at least one display characteristic of the existing interconnection graphical component is modified if the selected set of characteristics of the existing interconnection graphical component is similar to the selected set of characteristics of the specific interaction.

5. The graphical user interface of claim 1, wherein the interconnection graphical components are selectable to show data of associated interactions of the sequence of interactions.

6. The graphical user interface of claim 5, wherein the data of associated interactions is shown as a text display.

7. The graphical user interface of claim 6, wherein the text display is arranged to color-code the data of associated interactions based on a syntax of the data.

8. The graphical user interface of claim 1, wherein the interconnection graphical components are displayed in a scrollable window component.

9. The graphical user interface of claim 1, wherein the interconnection graphical components each include a text label describing an attribute of the associated interaction.

10. A graphical user interface for representing a sequence of interactions successively occurring over a period of time between Web service objects, comprising:
a plurality of Web service graphical components generally arranged in a row and representing associated Web service objects;
a plurality of interconnection graphical components each having at least two endpoints and oriented generally parallel to the row of the Web service graphical components, the interconnection graphical components displayed in a stack arrangement so that the endpoints of each interconnection graphical component are in alignment with at least two associated Web service graphical components; and
wherein the interconnection graphical components and Web service graphical components are each displayed according to the order of occurrence of an associated interaction of the sequence of interactions between the Web service objects.

11. The graphical user interface of claim 10, wherein the Web service graphical components each include an extension line extending substantially perpendicular from the row of the Web service graphical components, each interconnection graphical component coupled to the extension lines of at least two Web service components.

12. The graphical user interface of claim 10, wherein a new interconnection graphical component is displayed for each interaction of the sequence of interactions.

13. The graphical user interface of claim 10, wherein at least one display characteristic of an existing interconnection graphical component is modified if a selected set of characteristics of the existing interconnection graphical component is similar to a selected set of characteristics of a specific interaction, and a new interconnection graphical component is displayed for the specific interaction if no existing interconnection graphical component has a selected set of characteristics that is similar to the selected set of characteristics of the specific interaction.

14. A method of representing a sequence of interactions successively occurring over a period of time between Web service objects, comprising:
displaying a plurality of Web service graphical components representing the Web service objects and generally arranged in a row; and
displaying a plurality of interconnection graphical components, each representing an associated interaction of the sequence of interactions and sequentially displayed relative to the order of occurrence of the associated interaction, the interconnection graphical components each oriented generally parallel to the row of Web service graphical components and having endpoints in alignment with two or more Web service graphical components related to the associated interaction.

15. The method of claim 14, wherein displaying the Web service graphical components comprises displaying a plurality of extension lines extending from each Web service graphical component in an orientation substantially perpendicular to the Web service graphical components, and wherein displaying the plurality of interconnection graphical components comprises coupling the interconnection graphical components to two or more of the extension lines.

16. The method of claim 14, wherein displaying the plurality of interconnection graphical components comprises displaying a new interconnection graphical component for each interaction of the sequence of interactions.

17. The method of claim 14, wherein displaying the plurality of interconnection graphical components comprises displaying a new interconnection graphical component if an existing interconnection graphical component that represents another interaction has a selected set of characteristics that is different from a selected set of characteristics of the specific interaction, and at least one display characteristic of the existing interconnection graphical component is modified if the selected set of characteristics of the specific interaction is similar to the selected set of characteristics of the existing interconnection graphical component.

18. The method of claim 14, further comprising showing data of the sequence of interactions by selection of the interconnection graphical components.

19. The method of claim 18, wherein the showing the data of the sequence of interactions comprises showing a text display.

20. The method of claim 19, wherein showing the text display comprises color-coding the data of the sequence of interactions based on a syntax of the data.

21. The method of claim 14, wherein displaying the interconnection graphical components comprises displayed the interconnection graphical components in a scrollable window component.

22. The method of claim 14, further comprising displaying a text label describing an attribute of the associated interaction proximate each of the interconnection graphical components.

23. A computer-readable medium for providing a visual indication of a sequence of interactions successively occurring over a period of time between Web service objects, the computer readable medium configured with instructions for causing a computing device to perform steps comprising:
displaying a plurality of Web service graphical components generally arranged in a row, the Web service graphical components representing the Web service objects associated with the sequence of interactions; and
displaying a plurality of interconnection graphical components, each representing an associated interaction of the sequence of interactions and sequentially displayed relative to the order of occurrence of the associated interaction, the interconnection graphical components each oriented generally parallel to the row of Web service graphical components and having endpoints in alignment with two or more Web service graphical components related to the associated interaction.

24. The computer-readable medium of claim 23, wherein displaying the Web service graphical components comprises displaying a plurality of extension lines extending from each Web service graphical component in an orientation substantially perpendicular to the Web service graphical components, and displaying the plurality of interconnection graphical components comprises coupling the interconnection graphical components to two or more of the extension lines.

25. The computer-readable medium of claim 23, wherein displaying the plurality of interconnection graphical components comprises displaying a new interconnection graphical component for each interaction of the sequence of interactions.

26. The computer-readable medium of claim 23, wherein displaying the plurality of interconnection graphical components comprises displaying a new interconnection graphical component if an existing interconnection graphical component has a selected set of characteristics that is different from a selected set of characteristics of the specific interaction, and at least one display characteristic of the existing interconnection graphical component is modified if the selected set of characteristics of the existing interconnection graphical component is similar to the selected set of characteristics of the specific interaction.

27. The computer-readable medium of claim 23, wherein the steps further comprise showing data of the sequence of interactions by selecting the interconnection graphical components.

28. The computer-readable medium of claim 27, wherein the showing the data of the sequence of interactions comprises showing a text display.

29. The computer-readable medium of claim 28, wherein showing the text display comprises color-coding the data of the sequence of interactions based on a syntax of the data.

30. The computer-readable medium of claim 23, wherein displaying the interconnection graphical components comprises displayed the interconnection graphical components in a scrollable window component.

31. The computer-readable medium of claim 23, wherein the steps further comprise displaying a text label describing an attribute of the associated interaction proximate each of the interconnection graphical components.
